(19) United States
(12) Patent Application Publication
(10) Pub. No.: US 2020/0074558 A1
(43) Pub. Date: Mar. 5, 2020

(54) CLAIMS INSIGHT FACTORY UTILIZING A DATA ANALYTICS PREDICTIVE MODEL

(71) Applicant: HARTFORD FIRE INSURANCE COMPANY, Hartford, CT (US)

(72) Inventors: Justin L. Albert, Avon, CT (US); Willie F. Gray, Simsbury, CT (US); Lisa Anne Maguire, Glastonbury, CT (US); Kari Anne Palmer, Avon, CT (US); Matthew S. Sandberg, Hebron, CT (US)

(21) Appl. No.: 16/122,080

(22) Filed: Sep. 5, 2018

(51) Int. Cl. G06Q 40/08; G06Q 10/10

(52) U.S. Cl. CPC G06Q 40/08; G06Q 10/10

(57) ABSTRACT

The present application is directed to systems and methods adapted to automatically analyze insurance claim records, automatically identify risk drivers, automatically identify how these risk drivers affect insurance claim outcomes and automatically provide risk mitigation strategies that improve insurance claim outcomes.

### TECHNICAL FIELD

The present application generally relates to computer systems and more particularly to computer systems that are adapted to mine data to identify risk drivers and to develop risk mitigation strategies.

### BACKGROUND

Electronic insurance claim records may be stored and utilized by an Insurance Company. Moreover, the Insurance Company may be interested in analyzing information about risk drivers and insurance claim outcomes in each insurance claim record to model insurance claim outcomes based on different risk drivers. For example, the Insurance Company might want to advise customers how different identified risk drivers affect insurance claim outcomes and advise customers on adopting risk mitigation strategies for affecting insurance claim outcomes. Accordingly, the Insurance Company may add value to insurance products sold to customers by helping customers identify risk drivers that are affecting their insurance claim outcomes and their insurance costs. Further, the Insurance Company may add value to insurance products sold to customers by helping customers employ risk mitigation strategies that improve their insurance claim outcomes and reduce their insurance costs. Human analysis of electronic records to identify risk drivers, however, can be a time consuming, error prone and subjective process—especially where there are a substantial number of records to be analyzed (e.g., thousands of electronic records might need to be reviewed) and/or there are a lot of factors that could potentially influence insurance claim outcomes.

### SUMMARY

The present application is directed to systems and methods adapted to automatically analyze insurance claim records, automatically identify risk drivers, automatically identify how these risk drivers affect insurance claim outcomes and automatically provide risk mitigation strategies that improve insurance claim outcomes.

In one embodiment of the present application, a data analytics system includes a data mining engine, a predictive analytics engine and a claims insight platform. The data mining engine analyzes a plurality of insurance claim files to identify flags corresponding to risk drivers. The predictive analytics engine calculates a risk score for each of the plurality of insurance claim files based on identified flags corresponding to risk drivers. The claims insight platform selects a subset of the plurality of insurance claim files, calculates an average risk score for the subset of the plurality of insurance claim files, and determines an expected claim outcome based on the calculated average risk score for the subset of the plurality of insurance claim files.

In some of the embodiments of the above data analytics system, the predictive analytics engine implements a predictive model to calculate the likelihood of certain events occurring on the basis of risk drivers identified for each of the plurality of insurance claim files; and the risk score for each of the plurality of insurance claim files is based on the calculated likelihood of certain events occurring.

In some of the embodiments of the above data analytics system, the claims insight platform accesses a database of insurance claim records, each insurance claim record including associated risk score and claim outcome; and the claims insight platform determines the expected claim outcome for the calculated average risk score by analyzing the claim outcomes of insurance claim records having risk scores that are substantially the same as the calculated average risk score.

In some of the embodiments of the above data analytics system, the claims insight platform selects a second subset of the plurality of insurance claim files, calculates a second average risk score for the second subset of the plurality of insurance claim files, and determines a second expected claim outcome based on the calculated second average risk score for the second subset of the plurality of insurance claim files.

In some of the embodiments of the above data analytics system, the claims insight platform accesses a database of insurance claim records, each insurance claim record including associated risk score and claim outcome; and the claims insight platform determines the second expected claim outcome for the calculated second average risk score by analyzing the claim outcomes of insurance claim records having risk scores that are substantially the same as the calculated second average risk score.

In some of the embodiments of the above data analytics system, the claims insight platform compares the average risk score to the second average risk score and automatically generates a recommended action based on a difference between the average risk score and the second average risk score.

In some of the embodiments of the above data analytics system, the claims insight platform automatically generates an electronic message requesting confirmation that that the recommended action has been implemented.

In some of the embodiments of the above data analytics system, the claims insight platform compares the expected claim outcome to the second expected claim outcome and automatically generates a recommended action based on a difference between the expected claim outcome and the second expected claim outcome.

In some of the embodiments of the above data analytics system, the claims insight platform automatically generates an electronic message requesting confirmation that that the recommended action has been implemented.

In some of the embodiments of the above data analytics system, the claims insight platform generates an insurance claim record corresponding to each of the plurality of insurance claim files, each insurance claim record including associated risk score and claim outcome.

In one embodiment of the present application, a method of analyzing insurance claim data, includes receiving data for a plurality of insurance claim files, the data for each of the plurality of insurance claim files including the identification of flags corresponding to risk drivers; calculating a risk score for each of the plurality of insurance claim files based on the identified flags corresponding to risk drivers; selecting a subset of the plurality of insurance claim files; calculating an average risk score for the subset of the plurality of insurance claim files; and determining an expected claim outcome based on the calculated average risk score for the subset of the plurality of insurance claim files.

Some of the embodiments of the above method of analyzing insurance claim data, further include implementing a predictive model to calculate the likelihood of certain events occurring on the basis of risk drivers identified for each of the plurality of insurance claim files; wherein the risk score for each of the plurality of insurance claim files is based on the calculated likelihood of certain events occurring.

Some of the embodiments of the above method of analyzing insurance claim data, further include accessing a database of insurance claim records, each insurance claim record including associated risk score and claim outcome; wherein the expected claim outcome for the calculated average risk score is determined by analyzing the claim outcomes of insurance claim records having risk scores that are substantially the same as the calculated average risk score.

Some of the embodiments of the above method of analyzing insurance claim data, further include selecting a second subset of the plurality of insurance claim files; calculating a second average risk score for the second subset of the plurality of insurance claim files; and determining a second expected claim outcome based on the calculated second average risk score for the second subset of the plurality of insurance claim files.

Some of the embodiments of the above method of analyzing insurance claim data, further include accessing a database of insurance claim records, each insurance claim record including associated risk score and claim outcome; wherein the second expected claim outcome for the calculated second average risk score is determined by analyzing the claim outcomes of insurance claim records having risk scores that are substantially the same as the calculated second average risk score.

Some of the embodiments of the above method of analyzing insurance claim data, further include comparing the average risk score to the second average risk score and automatically generating a recommended action based on a difference between the average risk score and the second average risk score.

Some of the embodiments of the above method of analyzing insurance claim data, further include automatically generating an electronic message requesting confirmation that that the recommended action has been implemented.

Some of the embodiments of the above method of analyzing insurance claim data, further include comparing the expected claim outcome to the second expected claim outcome and automatically generating a recommended action based on a difference between the expected claim outcome and the second expected claim outcome.

Some of the embodiments of the above method of analyzing insurance claim data, further include automatically generating an electronic message requesting confirmation that that the recommended action has been implemented.

Some of the embodiments of the above method of analyzing insurance claim data, further include generating an insurance claim record corresponding to each of the plurality of insurance claim files, each insurance claim record including associated risk score and claim outcome.

### BRIEF DESCRIPTION OF THE DRAWINGS

The foregoing summary, as well as the following detailed description, is better understood when read in conjunction with the appended drawings. For the purpose of illustrating the invention, exemplary embodiments are shown in the drawings, it being understood, however, that the present application is not limited to the specific embodiments disclosed. In the drawings:

FIG. 1 is a schematic diagram of a Claims Insight Factory according to some embodiments;

FIG. 2 is a schematic diagram of an Insurance Claim Record according to some embodiments;

FIG. 3 is a view of a GUI according to some embodiments;

FIG. 4 is another view of a GUI according to some embodiments; and

FIG. 5 is a schematic workflow of a Claims Insight Factory according to some embodiments.

### DETAILED DESCRIPTION OF EMBODIMENTS OF THE INVENTION

Before the various exemplary embodiments are described in further detail, it is to be understood that the present invention is not limited to the particular embodiments described. It is also to be understood that the terminology used herein is for the purpose of describing particular embodiments only, and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data analytics. The present invention is directed to more than merely a computer implementation of a routine or conventional activity previously known in the industry as it provides a specific advancement in the area of electronic record analysis by providing improvements in data leveraging to identify risk factors, identify the effect of these risk factors on outcomes, and identify risk mitigation strategies to improve outcomes. The present invention provides improvement beyond a mere generic computer implementation as it involves the novel ordered combination of system elements and processes to provide improvements in data leveraging to identify risk factors, identify the effect of these risk factors on outcomes, and identify risk mitigation strategies to improve outcomes.

The present invention is directed to a Claims Insight Factory 10 adapted to automatically analyze insurance claim records, automatically identify risk drivers, automatically identify how these risk drivers affect insurance claim outcomes and automatically provide risk mitigation strategies that improve insurance claim outcomes.

In the context of the present application, Customer refers to an employer who purchases insurance coverage from an Insurance Company on behalf of its employees (i.e., the insured), the Insurance Company refers to the insurer that provides insurance coverage to the insured, and the claimant refers to an injured party who files an insurance claim. Further, in the context of the present application, risk factors refer to categories of risk that may affect the outcomes of insurance claims, including, e.g., social risk, psychological risk, biological risk, etc. Each of these risk factors (i.e., risk categories) includes specific risk drivers. For example, the risk drivers for social risk may include, e.g., employee skills, employer environment, employee satisfaction, etc.; risk drivers for psychological risk may include, e.g., depression, PTSD, etc.; risk drivers for biological risk may include, e.g., obesity, diabetes, etc.

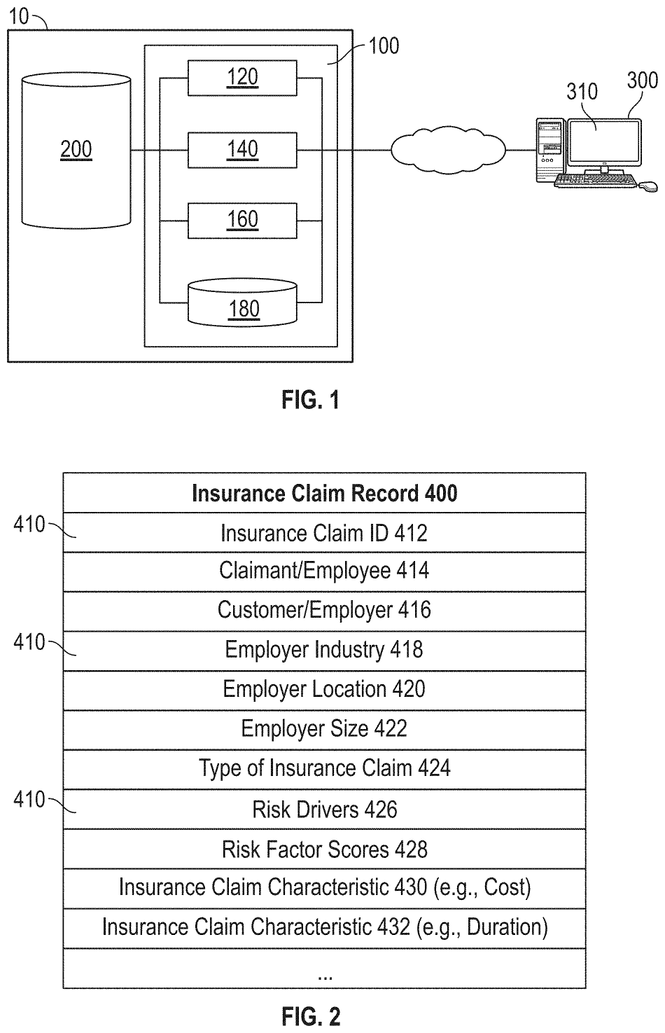

As shown in FIG. 1, Claims Insight Factory 10 includes one or more computer servers 100 in a centralized or distributed computing architecture. The computer server(s) 100 of Claims Insight Factory 10 may be configured to include Claims Insight Platform 120, Data Mining Engine 140, Predictive Analytics Engine 160 and Database 180. Further, as shown in FIG. 1, Claims Insight Factory 10 may include Claims Data Warehouse 200. Claims Insight Factory 10 communicates with remote Computing Device(s) 300 accessible by users. Computing Device(s) 300 may be any suitable device (e.g., PC, laptop, tablet, smartphone, etc.) for communicating with Claims Insight Factory 10 and rendering a GUI 310 to perform the functions described herein.

As used herein, devices, including computer server(s) 100, Claims Insight Platform 120, Data Mining Engine 140, Predictive Analytics Engine 160, Database 180, Claims Data Warehouse 200 and remote Computing Device(s) 300, may exchange information via any communication network which may be one or more of a telephone network, a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The functions of computer server(s) 100 described herein may be implemented using computer applications comprising computer program code stored in a non-transitory computer-readable medium that is executed by a computer processor. The functions of computer server(s) 100 described herein may also be implemented in programmable hardware devices such as field programmable gate arrays, programmable array logic, programmable logic devices or the like. Further, functions of computer server(s) 100 described herein may be implemented using some combination of computer program(s) executed by a computer processor and programmable hardware devices. Thus, computer server(s) 100 of the present application comprises suitable computer hardware and software for performing the desired functions and are not limited to any specific combination of hardware and software.

The executable computer program code may comprise one or more physical or logical blocks of computer instructions, which may be organized as an object, procedure, process or function. For example, the executable computer program code may be distributed over several different code partitions or segments, among different programs, and across several devices. Accordingly, the executable computer program need not be physically located together, but may comprise separate instructions stored in different locations which, when joined logically together, comprise the computer application and achieve the stated purpose for the computer application.

The Insurance Company collects insurance claim data (e.g., insurance claim files) associated with various types of insurance (e.g., Property and Casualty Insurance, Group Benefits Insurance, Workers' Compensation Insurance, etc.). The Insurance Company runs Extraction, Transformation, and Loading (ETL) processes on collected insurance claim data (e.g., insurance claim files). The processed insurance claim data (e.g., insurance claim files) is loaded into a Claims Data Warehouse 200. Accordingly, Claims Insight Factory 10 may comprise a Claims Data Warehouse 200 adapted to store insurance claim data (e.g., insurance claim files). Claims Data Warehouse 200 may comprise one or more Data Marts (e.g., Dimensional Data Mart, Analytic Data Mart, Legacy Data Mart) adapted for different business functions. Each insurance claim file stored in Claims Data Warehouse 200 may include insurance claim information such as, e.g., claimant/employee, customer/employer, employer industry, employer location, employer size, type of insurance claim (e.g., Property and Casualty, Group Benefits, Workers' Compensation, etc.), insurance claim cost, insurance claim duration, etc. In an alternative embodiment, Claims Insight Factory 10 does not comprise Claims Data Warehouse 200, but instead accesses insurance claim data (e.g., insurance claim files) in a stand-alone Claims Data Warehouse 200.

Claims Insight Factory 10 mines the claim data stored in Claims Data Warehouse 200 to automatically identify flags corresponding to certain risk drivers. Flags refer to items (e.g., text, codes, structured data fields, etc.) in insurance claim data (e.g., insurance claim files) that are indicative of certain risk drivers that may affect the outcomes of insurance claims. For example, Claims Insight Platform 120 may include a Data Mining Engine 140, e.g., such as the semantic rules system described in U.S. Pat. No. 9,026,551, which may be used to identify text flags (e.g., semantic events) in insurance claim data (e.g., insurance claim files) that trigger semantic rules. U.S. Pat. No. 9,026,551 is herein incorporated by reference in its entirety. Accordingly, Data Mining Engine 140 may determine certain risk drivers associated with an insurance claim file based on the triggering of corresponding flags. For example, certain semantic rules may be associated with certain risk drivers, such that the triggering of a semantic rule leads to the identification of a corresponding risk driver. Thus, Claims Insight Platform 120 may collect metrics of risk drivers for each insurance claim file in Claims Data Warehouse 200. In an alternative embodiment, Claims Insight Platform 120 does not comprise Data Mining Engine 140, but instead may collect metrics of risk drivers for each insurance claim file in Claims Data Warehouse 200 by directing a stand-alone Data Mining Engine 140.

Claims Insight Factory 10 uses the determination of certain risk drivers associated with an insurance claim file to calculate one or more risk factor scores corresponding to one or more risk factors for the insurance claim file. For example, Claims Insight Factory 10 may first use the determination of certain risk drivers associated with an insurance claim file to calculate the likelihood of certain events occurring (e.g., events delaying recovery in disability claims, subrogation, fraud, etc.). Then, for each insurance claim file, Claims Insight Factory 10 may assign one or more risk factor scores corresponding to one or more risk factors based on the calculated likelihood of certain events occurring on the basis of the identified risk drivers.

Accordingly, Claims Insight Platform 120 may include a Predictive Analytics Engine 160 that uses as an input the risk drivers associated with an insurance claim file and produces an output of one or more risk factor scores corresponding to one or more risk factors associated with the insurance claim file. Predictive Analytics Engine 160 may comprise a knowledge base of historical insurance claim data and predictive models that can be implemented with the knowledge base to calculate the one or more risk factor scores corresponding to one or more risk factors associated with the insurance claim file on the basis of the identified risk drivers. Accordingly, for each claim file, Predictive Analytics Engine 160 may generate risk factor scores for different risk factors (e.g., social risk score, psychological risk score, biological risk score, etc.) on the basis of the risk drivers identified for the insurance claim file. In an alternative embodiment, Claims Insight Platform 120 does not comprise Predictive Analytics Engine 160, but instead may collect risk factor scores for different risk factors (e.g., social risk score, psychological risk score, biological risk score, etc.) on the basis of the risk drivers identified for insurance claim files in Claims Data Warehouse 200 by directing a stand-alone Predictive Analytics Engine 160.

Claims Insight Factory 10 may further include a Database 180 for storing insurance claim records 400 for associating information for each insurance claim file. As shown in FIG. 2, claim records 400 may include information stored in fields 410 including, e.g., insurance claim ID 412, claimant/employee 414, customer/employer 416, employer industry 418, employer location 420, employer size 422, type of insurance claim 424 (e.g., Property and Casualty, Group Benefits, Workers' Compensation, etc.), identified risk drivers 426, risk factor scores 428, insurance claim characteristics (e.g., Insurance Claim Cost 430, Insurance Claim Duration 432), etc. Insurance Claim Cost may refer to the expense to the Insurance Company for covering the insurance claim, and Insurance Claim Duration may refer to the amount of time the Insurance Company provides benefits for the insurance claim. For example, for a worker's compensation claim, the cost may refer to medical expenses and other expenses (e.g., disability benefits, rehabilitation benefits, death benefits, etc.), and the duration may refer to the amount of time a claimant receives benefits for being unable to fully or partially perform their work.

The insurance claim information collected, generated and stored may be leveraged by Claims Insight Factory 10 to provide benchmarking information. More particularly, Claims Insight Factory 10 may benchmark the risk factor scores for insurance claim files of an analysis group against the risk factor scores for insurance claim files of a baseline group. Also, Claims Insight Factory 10 may benchmark the claim outcomes (e.g., claim characteristics) of insurance claim files of an analysis group against the claim outcomes (e.g., claim characteristics) of insurance claim files of a baseline group. The analysis group of insurance claim files is selected based on analysis selection criteria, and the baseline group of insurance claims is selected based on baseline selection criteria. Analysis selection criteria for selecting an analysis group of insurance claim files may be a field 410 attribute or combination of field 410 attributes in insurance claim records 400 stored in Database 180. Likewise, baseline selection criteria for selecting a baseline group of insurance claim files may also be a field 410 attribute or combination of field 410 attributes in insurance claim records 400 stored in Database 180. For example, the risk factor scores for the insurance claim files of a selected customer may be benchmarked against the risk factor scores for the insurance claim files of other customers in the same industry, in the same geographical region and/or of about the same size (e.g., number of employees).

Claims Insight Factory 10 includes a Claims Insight Platform 120. Once the analysis selection criteria for the analysis group are entered in Claims Insight Platform 120, Claims Insight Platform 120 queries Database 180 for insurance claim records satisfying the analysis selection criteria. Claims Insight Platform 120 then determines composite risk factor scores for the insurance claim files of the analysis group according to a selected analysis composite score basis (e.g., customer-by-customer basis, claimant-by-claimant basis, etc.). Claims Insight Platform 120 may calculate a composite risk factor score for a selected risk factor according to the selected analysis composite score basis by taking the average of all the risk factor scores for the selected risk factor for the insurance claim files of the analysis group according to the selected analysis composite score basis.

For example, if the analysis selection criterion is a selected customer, then the Database 180 query returns all the insurance claim records 400 associated with the selected customer (i.e., the analysis group of insurance claim files). Then, Claims Insight Platform 120 may calculate composite risk factor scores for the insurance claim files of the analysis group according to a selected analysis composite score basis (e.g., customer-by-customer basis, claimant-by-claimant basis, etc.). For instance, if the analysis composite score basis is a customer-by-customer basis, Claims Insight Platform 120 may calculate the composite social risk factor score for the selected customer by taking the average of all the social risk factor scores for all the insurance claim files associated with the selected customer. Similarly, Claims Insight Platform 120 may calculate the composite psychological risk factor score for the selected customer by taking the average of all the psychological risk factor scores for all the insurance claim files associated with the selected customer. Further, Claims Insight Platform 120 may calculate the composite biological risk factor score for the selected customer by taking the average of all the biological risk factor scores for all the insurance claim files associated with the selected customer.

In another example, if the analysis composite score basis is a claimant-by-claimant basis, Claims Insight Platform 120 may calculate the composite social risk factor score for each claimant in the analysis group by taking the average of the social risk factor scores for the insurance claim files on a claimant-by-claimant basis. Similarly, Claims Insight Platform 120 may calculate the composite psychological risk factor score for each claimant in the analysis group by taking the average of the psychological risk factor scores for the insurance claim files on a claimant-by-claimant basis. Further, Claims Insight Platform 120 may calculate the composite biological risk factor score for each claimant in the analysis group by taking the average of the biological risk factor scores for the insurance claim files on a claimant-by-claimant basis.

Once the baseline selection criteria for the baseline group are entered in Claims Insight Platform 120, Claims Insight Factory 10 queries Database 180 for insurance claim records 400 satisfying the baseline selection criteria. Claims Insight Platform 120 then determines composite risk factor scores for the insurance claim files of the baseline group according to a selected baseline composite score basis (e.g., customer-by-customer basis, claimant-by-claimant basis, etc.). Claims Insight Platform 120 may calculate a composite risk factor score for a selected risk factor by taking the average of all the risk factor scores for the selected risk factor for the insurance claim files of the baseline group according to the selected baseline composite score basis (e.g., customer-by-customer basis, claimant-by-claimant basis, etc.).

For example, if the baseline selection criterion is a selected industry, then the Database 180 query returns all the insurance claim records 400 associated with the selected industry (i.e., the baseline group of insurance claim files). If the baseline selection criteria is a selected geographic region and a selected company size range (e.g., 500-1,000 employees), then the Database 180 query returns all of the insurance claim records 400 associated with the selected geographic region and company size range (i.e., the baseline group of insurance claim files). Then, Claims Insight Platform 120 may calculate composite risk factor scores for the insurance claim files of the baseline group according to a selected baseline composite score basis (e.g., customer-by-customer basis, claimant-by-claimant basis, etc.). For instance, if the baseline composite score basis is a customer-by-customer basis, then Claims Insight Platform 120 may calculate the composite social risk factor score for each customer in the baseline group by taking the average of the social risk factor scores for the insurance claim files on a customer-by-customer basis. Similarly, Claims Insight Platform 120 may calculate the composite psychological risk factor score for each customer in the baseline group by taking the average of the psychological risk factor scores for the insurance claim files on a customer-by-customer basis. Further, Claims Insight Platform 120 may calculate the composite biological risk factor score for each customer in the baseline group by taking the average of the biological risk factor scores for the insurance claim files on a customer-by-customer basis.

In another example, if the baseline composite score basis is a claimant-by-claimant basis, Claims Insight Platform 120 may calculate the composite social risk factor score for each claimant in the baseline group by taking the average of the social risk factor scores for the insurance claim files on a claimant-by-claimant basis. Similarly, Claims Insight Platform 120 may calculate the composite psychological risk factor score for each claimant in the analysis group by taking the average of the psychological risk factor scores for the insurance claim files on a claimant-by-claimant basis. Further, Claims Insight Platform 120 may calculate the composite biological risk factor score for each claimant in the analysis group by taking the average of the biological risk factor scores for the insurance claim files on a claimant-by-claimant basis.

Further, Claims Insight Platform 120 may provide users access to Claims Insight Factory 10 via GUIs 310 rendered on remote computing devices 300 in communication with Claims Insight Platform 120. For instance, a user may enter the analysis selection criteria, analysis composite score basis, baseline selection criteria and baseline composite score basis via a GUI 310 rendered on a computing device 300 in communication with Claims Insight Platform 120. Further, Claims Insight Platform 120 provides users benchmarking analysis according to the selected analysis selection criteria, analysis composite score basis, baseline selection criteria and baseline composite score basis received from the user via the GUI 310 rendered on the computing device 300.

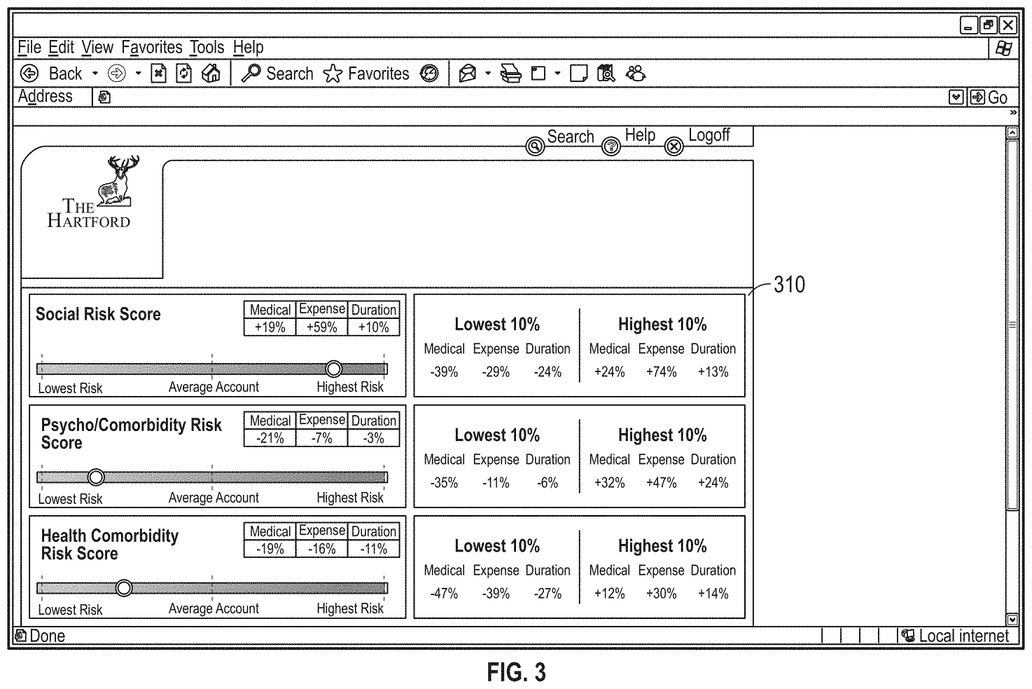

For example, Claims Insight Platform 120 may execute benchmark analysis of the risk factor scores for insurance claim files of an analysis group against the risk factor scores for insurance claim files of a baseline group in accordance with user specified analysis selection criteria, analysis composite score basis, baseline selection criteria and baseline composite score basis. FIG. 3 shows an exemplary GUI 310 illustrating an exemplary benchmark analysis executed by Claims Insight Platform 120. For the benchmark analysis of FIG. 3, the analysis selection criteria is the selected customer, the analysis composite score basis is a customer-by-customer basis, the baseline selection criteria is the industry of the selected customer and the baseline composite score basis is a customer-by-customer basis.

FIG. 3 shows an analysis of risk factor scores (e.g., social risk score, psychological risk score, biological risk score) for insurance claim files associated with the selected customer compared against the risk factor scores for the insurance claim files of other customers in the same industry as the selected customer. The benchmark analysis provides an indication of how the selected customer's risk factor scores (e.g., social risk score, psychological risk score, biological risk score) compare to the risk factor scores of other customers in the same industry. As shown in the benchmark analysis of FIG. 3, the social risk score for the selected customer is higher than average and is near the highest end of the spectrum for customers in the same industry; the psychological risk score for the selected customer is lower than average and is near the lowest end of the spectrum for customers in the same industry; and the biological risk score for the selected customer is lower than average and is between the lowest end and the median point of the spectrum for customers in the same industry.

Additionally, the benchmark analysis may include an indication of how the risk factor scores for the insurance claim files of the analysis group affect the claim outcomes (e.g., claim characteristics) of different types of claims compared to the risk factor scores for the insurance claim files of the baseline group. For example, for a given bench mark analysis for the risk factor scores of an analysis group compared to the risk factor scores of a baseline group, Claims Insight Platform 120 may calculate how the risk factor scores for the insurance claim files of the analysis group affect the claim outcomes (e.g., claim characteristics) of a selected type of insurance claim (e.g., Property and Casualty, Group Benefits, Workers' Compensation, etc.) compared to the risk factor scores for the insurance claim files of the baseline group. The benchmark analysis of FIG. 3 shows how the selected customer's risk factor scores (e.g., social risk score, psychological risk score, biological risk score) affect the claim characteristics (e.g., medical expense, other expense, duration) for workers' compensation insurance claims compared to the risk factor scores of other customers in the same industry.

The bench mark analysis of FIG. 3 shows that the relatively high social risk score for the analysis group (e.g., the selected customer) results in workers' compensation claims with 19% higher Medical Expenses, 59% higher Other Expenses and 10% longer Duration compared to the average social risk score for the baseline group (e.g., other customers in the same industry). The bench mark analysis of FIG. 3 also shows that the lowest 10% social risk scores for the baseline group (e.g., other customers in the same industry) result in workers' compensation claims with 39% lower Medical Expenses, 29% lower Other Expenses and 24% shorter Duration compared to the social risk score for the analysis group (e.g., the selected customer). The bench mark analysis of FIG. 3 further shows that the highest 10% social risk scores for the baseline group (e.g., other customers in the same industry) result in workers' compensation claims with 24% higher Medical Expenses, 74% higher Other Expenses and 13% longer Duration compared to the social risk score for the analysis group (e.g., the selected customer).

The bench mark analysis of FIG. 3 shows that the relatively low psychological risk score for the analysis group (e.g., the selected customer) results in workers' compensation claims with 21% A lower Medical Expenses, 7% lower Other Expenses and 3% shorter Duration compared to the average psychological risk score for the baseline group (e.g., other customers in the same industry). The bench mark analysis of FIG. 3 also shows that the lowest 10% psychological risk scores for the baseline group (e.g., other customers in the same industry) result in workers' compensation claims with 35% lower Medical Expenses, 11% A lower Other Expenses and 6% shorter Duration compared to the psychological risk score for the analysis group (e.g., the selected customer). The bench mark analysis of FIG. 3 further shows that the highest 10% psychological risk scores for the baseline group (e.g., other customers in the same industry) result in workers' compensation claims with 32% higher Medical Expenses, 47% higher Other Expenses and 24% longer Duration compared to the psychological risk score for the analysis group (e.g., the selected customer).

The bench mark analysis of FIG. 3 shows that the relatively low biological risk score for the analysis group (e.g., the selected customer) results in workers' compensation claims with 19% lower Medical Expenses, 16% lower Other Expenses and 11% A shorter Duration compared to the average biological risk score for the baseline group (e.g., other customers in the same industry). The bench mark analysis of FIG. 3 also shows that the lowest 10% biological risk scores for the baseline group (e.g., other customers in the same industry) result in workers' compensation claims with 47% lower Medical Expenses, 39% lower Other Expenses and 27% shorter Duration compared to the biological risk score for the analysis group (e.g., the selected customer). The bench mark analysis of FIG. 3 further shows that the highest 10% biological risk scores for the baseline group (e.g., other customers in the same industry) result in workers' compensation claims with 12% higher Medical Expenses, 30% higher Other Expenses and 14% longer Duration compared to the social risk score for the analysis group (e.g., the selected customer).

Claims Insight Platform 120 may execute the claim characteristics analysis for a selected type of insurance claim based on stored historical data of insurance claim records 400 for the selected type of insurance claim. Claims Insight Platform 120 may query Database 180 for insurance claim records 400 for the selected type of insurance claim that have the same risk factor scores as the analysis group and the same risk factor scores as some specified risk factor scores of the baseline group. Then, Claims Insight Platform 120 may calculate the average claim characteristic values for the insurance claim records 400 having the same risk factor scores as the analysis group and the same risk factor scores as some specified risk factor scores of the baseline group. In the context of the risk factor scores, “same” does not necessarily mean identical and may mean substantially the same within a specified range (e.g., +/−5%).

For instance, for the bench mark analysis of FIG. 3, Claims Insight Platform 120 may query Database 180 for insurance claim records 400 for the selected type of insurance claim (e.g., workers' compensation claims) that have the same social risk score, psychological risk score or biological risk score as the analysis group (e.g., the selected customer). Accordingly, the database query will return insurance claim records 400 for workers' compensation claims that have the same social risk score as the analysis group (e.g., the selected customer), insurance claim records 400 for workers' compensation claims that have the same psychological risk score as the analysis group (e.g., the selected customer) and insurance claim records 400 for workers' compensation claims that have the same biological risk score as the analysis group (e.g., the selected customer).

Then, based on the insurance claim information associated with the insurance claim records 400 returned by the query, Claims Insight Platform 120 may calculate the average claim characteristic values (e.g., medical expenses, other expenses and duration) corresponding to each risk factor score (e.g., social risk score, psychological risk score, biological risk score) of the analysis group (e.g., the selected customer). For example, for the bench mark analysis of FIG. 3, Claims Insight Platform 120 calculates the average medical expense value, average other expense value and average duration value for insurance claim records 400 returned by the query having the same social risk score as the analysis group (e.g., the selected customer). Similarly, Claims Insight Platform 120 calculates the average medical expense value, average other expense value and average duration value for insurance claim records 400 returned by the query having the same psychological risk score as the analysis group (e.g., the selected customer). Further, Claims Insight Platform 120 calculates the average medical expense value, average other expense value and average duration value for insurance claim records 400 returned by the query having the same biological risk score as the analysis group (e.g., the selected customer).

Also, for the bench mark analysis of FIG. 3, Claims Insight Platform 120 may query Database 180 for insurance claim records 400 for the selected type of insurance claim (e.g., workers' compensation claims) that have the same social risk score, psychological risk score or biological risk score as some specified risk factor score (e.g., average, highest 10%, lowest 10%, etc.) of the baseline group (e.g., other customers in the same industry). Accordingly, the database query will return insurance claim records 400 for workers' compensation claims that have the same social risk score as some specified social risk factor Score (e.g., average, highest 10%, lowest 10%, etc.) of the baseline group (e.g., other customers in the same industry), insurance claim records 400 for workers' compensation claims that have the same psychological risk score as some specified psychological risk factor score (e.g., average, highest 10%, lowest 10%, etc.) of the baseline group (e.g., other customers in the same industry) and insurance claim records 400 for workers' compensation claims that have the same biological risk score as some specified biological risk factor score (e.g., average, highest 10%, lowest 10%, etc.) of the baseline group (e.g., other customers in the same industry).

Then, based on the insurance claim information associated with the insurance claim records 400 returned by the query, Claims Insight Platform 120 may calculate the average claim characteristic values (e.g., medical expenses, other expenses and duration) corresponding to each specified risk factor score (e.g., social risk score, psychological risk score, biological risk score) of the baseline group (e.g., other customers in the same industry). For example, for the bench mark analysis of FIG. 3, Claims Insight Platform 120 calculates the average medical expense value, average other expense value and average duration value for insurance claim records 400 having a social risk score that is the same as the average social risk score of the baseline group; the average medical expense value, average other expense value and average duration value for insurance claim records 400 having social risk scores that are the same as the lowest 10% social risk scores of the baseline group; and the average medical expense value, average other expense value and average duration value for insurance claim records 400 having social risk scores that are the same as the highest 10% social risk scores of the baseline group. Similarly, Claims Insight Platform 120 calculates the average medical expense value, average other expense value and average duration value for insurance claim records 400 having a psychological risk score that is the same as the average psychological risk score of the baseline group; the average medical expense value, average other expense value and average duration value for insurance claim records 400 having psychological risk scores that are the same as the lowest 10% psychological risk scores of the baseline group; and the average medical expense value, average other expense value and average duration value for insurance claim records 400 having psychological risk scores that are the same as the highest 10% social risk scores of the baseline group. Further, Claims Insight Platform 120 calculates the average medical expense value, average other expense value and average duration value for insurance claim records 400 having a biological risk score that is the same as the average biological risk score of the baseline group; the average medical expense value, average other expense value and average duration value for insurance claim records 400 having biological risk scores that are the same as the lowest 10% biological risk scores of the baseline group; and the average medical expense value, average other expense value and average duration value for insurance claim records 400 having biological risk scores that are the same as the highest 10% biological risk scores of the baseline group.

Accordingly, based on Claims Insight Platform's 120 calculations described above, Claims Insight Platform 120 may determine how claim characteristic values for insurance claims having the same risk factor score as the analysis group compare to the claim characteristic values of insurance claims having some specified value of the risk factor score (e.g., average, highest 10%, lowest 10%, etc.) of the baseline group. As shown in the benchmark analysis of FIG. 3, Claims Insight Platform 120 may provide an indication (e.g., +/− percentage values) of how claim characteristic values for insurance claims having one risk factor score compare to the claim characteristic values of insurance claims having another risk factor score.

Also, Claims Insight Platform 120 may provide account level data aggregations or claimant level data aggregations by aggregating information for all insurance claim records 400 associated with a selected account or a selected claimant, respectively. Thus, Claims Insight Platform 120 may provide insurance claim information on an account wide basis or a claimant-by-claimant basis. Also, the metrics of risk drivers for insurance claim files associated with a particular account may be aggregated to generate an account profile. Account profile may define different risk factors (i.e., risk categories), including, e.g., social risk, psychological risk, biological risk, etc., and may identify an account's specific risk drivers for each risk factor. Similarly, the metrics of risk drivers for insurance claim files associated with a particular claimant may be aggregated to generate a claimant profile. Claimant profile may define different risk factors (i.e., risk categories), including, e.g., social risk, psychological risk, biological risk, etc., and may identify a claimant's specific risk drivers for each risk factor.

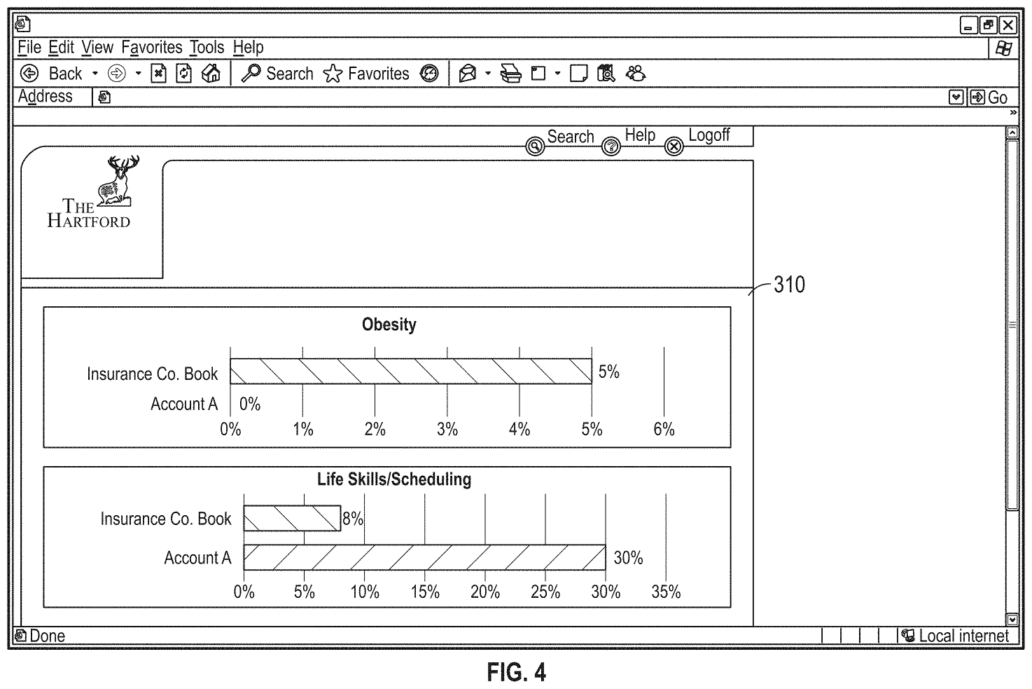

FIG. 4 shows an exemplary view of an account profile, which shows key risk drivers for insurance claims associated with the account in comparison with insurance claims for the Insurance Company's entire book. As shown in FIG. 4, obesity and life skills/scheduling are identified as two key risk drivers for the account. For example, obesity is flagged as a risk driver in 0% of the insurance claims for the account, whereas obesity is generally flagged in 5% of the insurance claims for the Insurance Company's entire book. Thus, obesity (or lack thereof) may be a key driver of the good health of the account relative to the Insurance Company's entire book, which may positively affect insurance claim outcomes. Life skills/scheduling is flagged as a risk driver in 30% of the insurance claims for the account, whereas life skills/scheduling is generally flagged in 8% of the insurance claims for the Insurance Company's entire book. Thus, life skills/scheduling (or lack thereof) may be a key driver for missed appointments and difficulty reaching claimants for the account relative to the Insurance Company's entire book, which may negatively affect insurance claim outcomes.

Claims Insight Platform 120 may automatically generate a report for any benchmark analysis performed and may automatically send the benchmark analysis report to the customer/employer and/or claimant/employee. Also, Claims Insight Platform 120 may automatically generate reports for account profiles and claimant profiles and may automatically send the account profile reports and claimant profile reports to their respective customer/employer and claimant/employee. Additionally, benchmark analysis reports, account profile reports and claimant profile reports may be stored by Claims Insight Platform 120 and accessed and viewed by users via the GUI 310 rendered on a computer device.

Additionally, the information identified in benchmark analysis reports account profile reports and claimant profile reports (e.g., identification of key risk drivers, benchmarking of risk factors) may be leveraged by Claims Insight Factory 10 to provide risk mitigation recommendations to claimants/employees and/or customers/employers. For example, Claims Insight Platform 120 may automatically generate recommendations for claimants/employees and/or customers/employers based on information identified in benchmark analysis reports, account profile reports and claimant profile reports (e.g., identification of key risk drivers, benchmarking of risk factors). For example, if Claims Insight Platform's 120 data analysis reveal that there are certain risk drivers that are negatively affecting insurance claim outcomes, Claims Insight Platform 120 may automatically generate recommendations to help claimants/employees or customers/employers address some of the identified key risk drivers.

The nature of the recommendations will depend on the nature of the risk drivers. For example, if an identified risk driver is missed medical appointments, then Claims Insight Platform 120 may recommend providing appointment reminders, transportation services and/or more conveniently located medical service providers. In another example, if an identified risk driver is bad relationship with medical service provider, then Claims Insight Platform 120 may recommend switching medical service provider. Claims Insight Platform 120 provides actionable items in the form of risk mitigation services and/or risk mitigation strategies that are aimed at preventing loss and/or decreasing the duration of loss. To that end, Claims Insight Platform 120 may automatically follow up with claimants/employees and/or customers/employers via automated electronic communication (e.g., email, text message, phone call, etc.) to confirm that recommended actionable items were carried out.

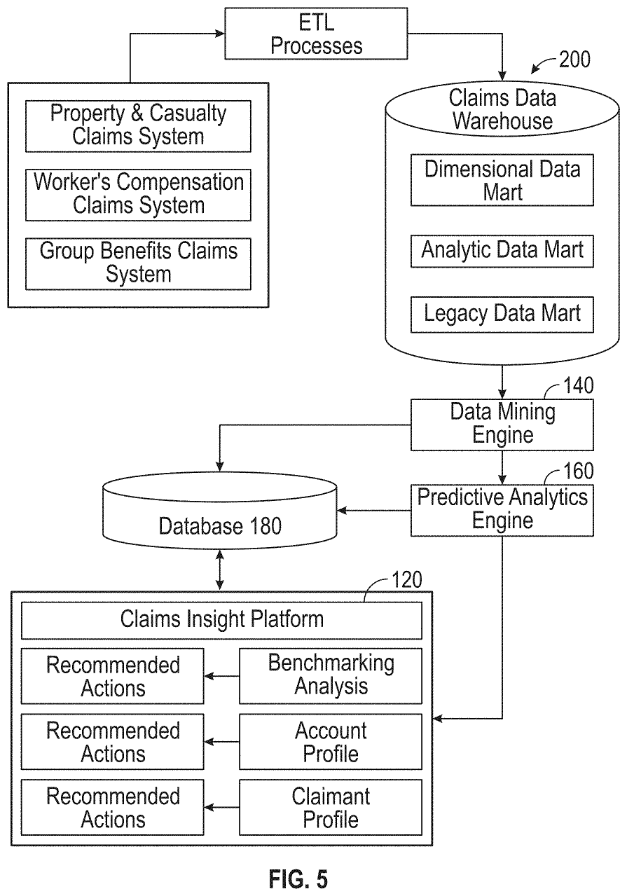

FIG. 5 shows an exemplary flow diagram for the operation of the exemplary Claims Insight Factory 10 of FIG. 1. Insurance claim data (e.g., insurance claim files) is associated with various types of insurance (e.g., Property and Casualty Insurance, Group Benefits Insurance, Workers' Compensation Insurance, etc.) is collected. ETL processes are run on the collected insurance claim data (e.g., insurance claim files). The processed insurance claim data (e.g., insurance claim files) is loaded into a Claims Data Warehouse 200. Claims Data Warehouse 200 is adapted to store insurance claim data (e.g., insurance claim files) and may comprise one or more Data Marts (e.g., Dimensional Data Mart, Analytic Data Mart, Legacy Data Mart) adapted for different business functions. Each insurance claim file stored in Claims Data Warehouse 200 may include insurance claim information such as, e.g., claimant/employee, customer/employer, employer industry, employer location, employer size, type of insurance claim (e.g., Property and Casualty, Group Benefits, Workers' Compensation, etc.), insurance claim cost, insurance claim duration, etc.

Claims Insight Factory 10 mines the claim data stored in Claims Data Warehouse 200 to automatically identify flags corresponding to certain risk drivers. Flags refer to items (e.g., text, codes, structured data fields, etc.) in insurance claim data (e.g., insurance claim files) that are indicative of certain risk drivers that may affect the outcomes of insurance claims. For example, Claims Insight Factory 10 may include a Data Mining Engine 140, e.g., such as the semantic rules system described in U.S. Pat. No. 9,026,551, which may be used to identify text flags (e.g., semantic events) in insurance claim data (e.g., insurance claim files) that trigger semantic rules. U.S. Pat. No. 9,026,551 is herein incorporated by reference in its entirety. Thus, Claims Insight Factory 10 may collect metrics of risk drivers for each insurance claim file in Claims Data Warehouse 200.

Claims Insight Factory 10 uses the determination of certain risk drivers associated with an insurance claim file to calculate one or more risk factor scores corresponding to one or more risk factors for the insurance claim file. For example, Claims Insight Factory 10 may include a Predictive Analytics Engine 160 that uses as an input the risk drivers associated with an insurance claim file and produces an output of one or more risk factor scores corresponding to one or more risk factors associated with the insurance claim file. Predictive Analytics Engine 160 may comprise a knowledge base of historical insurance claim data and predictive models that can be implemented with the knowledge base to calculate the one or more risk factor scores corresponding to one or more risk factors associated with the insurance claim file on the basis of the identified risk drivers. Accordingly, for each claim file, Predictive Analytics Engine 160 may generate risk factor scores for different risk factors (e.g., social risk score, psychological risk score, biological risk score, etc.) on the basis of the risk drivers identified for the insurance claim file.

Claims Insight Factory 10 may further include a Database 180 for storing insurance claim records 400 for associating information for each insurance claim file, including information determined/generated by Data Mining Engine 140 and Predictive Analytics Engine 160. As shown in FIG. 2, claim records 400 may include information stored in fields 410 including, e.g., insurance claim ID 412, claimant/employee 414, customer/employer 416, employer industry 418, employer location 420, employer size 422, type of insurance claim 424 (e.g., Property and Casualty, Group Benefits, Workers' Compensation, etc.), identified risk drivers 426, risk factor scores 428, insurance claim characteristics (e.g., Insurance Claim Cost 430, Insurance Claim Duration 432), etc.

The insurance claim information collected, generated and stored may be leveraged by Claims Insight Factory 10 to provide benchmarking information. More particularly, Claims Insight Factory 10 may benchmark the risk factor scores for insurance claim files of an analysis group against the risk factor scores for insurance claim files of a baseline group. Also, Claims Insight Factory 10 may benchmark the claim outcomes (e.g., claim characteristics) of insurance claim files of an analysis group against the claim outcomes (e.g., claim characteristics) of insurance claim files of a baseline group. Claims Insight Platform 120 may execute the claim characteristics analysis for a selected type of insurance claim based on stored historical data of insurance claim records 400 for the selected type of insurance claim. Also, Claims Insight Platform 120 may provide account level data aggregations or claimant level data aggregations by aggregating information for all insurance claim records 400 associated with a selected account or a selected claimant, respectively. Thus, Claims Insight Platform 120 may provide insurance claim information on an account wide basis or a claimant-by-claimant basis. Also, the metrics of risk drivers for insurance claim files associated with a particular account may be aggregated to generate an account profile. Similarly, the metrics of risk drivers for insurance claim files associated with a particular claimant may be aggregated to generate a claimant profile.

Claims Insight Platform 120 may automatically generate a report for any benchmark analysis performed and may automatically send the benchmark analysis report to the customer/employer and/or claimant/employee. Also, Claims Insight Platform 120 may automatically generate reports for account profiles and claimant profiles and may automatically send the account profile reports and claimant profile reports to their respective customer/employer and claimant/employee. Additionally, benchmark analysis reports, account profile reports and claimant profile reports may be stored by Claims Insight Platform 120 and accessed and viewed by users via the GUI 310 rendered on a computer device.

Additionally, the information identified in benchmark analysis reports account profile reports and claimant profile reports (e.g., identification of key risk drivers, benchmarking of risk factors) may be leveraged by Claims Insight Factory 10 to provide risk mitigation recommendations to claimants/employees and/or customers/employers. For example, Claims Insight Platform 120 may automatically generate recommendations for claimants/employees and/or customers/employers based on information identified in benchmark analysis reports, account profile reports and claimant profile reports (e.g., identification of key risk drivers, benchmarking of risk factors). For example, if Claims Insight Platform's 120 data analysis reveal that there are certain risk drivers that are negatively affecting insurance claim outcomes, Claims Insight Platform 120 may automatically generate recommendations to help claimants/employees or customers/employers address some of the identified key risk drivers.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A data analytics system comprising:
a data mining engine analyzing a plurality of insurance claim files to identify flags corresponding to risk drivers;
a predictive analytics engine calculating a risk score for each of the plurality of insurance claim files based on identified flags corresponding to risk drivers; and
a claims insight platform selecting a subset of the plurality of insurance claim files, the claims insight platform calculating an average risk score for the subset of the plurality of insurance claim files, and the claims insight platform determining an expected claim outcome based on the calculated average risk score for the subset of the plurality of insurance claim files.

2. The data analytics system according to claim 1, wherein the predictive analytics engine implements a predictive model to calculate the likelihood of certain events occurring on the basis of risk drivers identified for each of the plurality of insurance claim files; and
wherein the risk score for each of the plurality of insurance claim files is based on the calculated likelihood of certain events occurring.

3. The data analytics system according to claim 1, wherein the claims insight platform accesses a database of insurance claim records, each insurance claim record including associated risk score and claim outcome; and
wherein the claims insight platform determines the expected claim outcome for the calculated average risk score by analyzing the claim outcomes of insurance claim records having risk scores that are substantially the same as the calculated average risk score.

4. The data analytics system according to claim 1, wherein the claims insight platform selects a second subset of the plurality of insurance claim files, the claims insight platform calculates a second average risk score for the second subset of the plurality of insurance claim files, and the claims insight platform determines a second expected claim outcome based on the calculated second average risk score for the second subset of the plurality of insurance claim files.

5. The data analytics system according to claim 4, wherein the claims insight platform accesses to a database of insurance claim records, each insurance claim record including associated risk score and claim outcome; and
wherein the claims insight platform determines the second expected claim outcome for the calculated second average risk score by analyzing the claim outcomes of insurance claim records having risk scores that are substantially the same as the calculated second average risk score.

6. The data analytics system according to claim 5, wherein the claims insight platform compares the average risk score to the second average risk score and automatically generates a recommended action based on a difference between the average risk score and the second average risk score.

7. The data analytics system according to claim 6, wherein the claims insight platform automatically generates an electronic message requesting confirmation that that the recommended action has been implemented.

8. The data analytics system according to claim 5, wherein the claims insight platform compares the expected claim outcome to the second expected claim outcome and automatically generates a recommended action based on a difference between the expected claim outcome and the second expected claim outcome.

9. The data analytics system according to claim 8, wherein the claims insight platform automatically generates an electronic message requesting confirmation that that the recommended action has been implemented.

10. The data analytics system according to claim 1, wherein the claims insight platform generates an insurance claim record corresponding to each of the plurality of insurance claim files, each insurance claim record including associated risk score and claim outcome.

11. A method of analyzing insurance claim data, comprising:
receiving data for a plurality of insurance claim files, the data for each of the plurality of insurance claim files including the identification of flags corresponding to risk drivers;
calculating a risk score for each of the plurality of insurance claim files based on the identified flags corresponding to risk drivers;
selecting a subset of the plurality of insurance claim files;
calculating an average risk score for the subset of the plurality of insurance claim files; and
determining an expected claim outcome based on the calculated average risk score for the subset of the plurality of insurance claim files.

12. The method according to claim 11, further comprising:
implementing a predictive model to calculate the likelihood of certain events occurring on the basis of risk drivers identified for each of the plurality of insurance claim files; and
wherein the risk score for each of the plurality of insurance claim files is based on the calculated likelihood of certain events occurring.

13. The method according to claim 11, further comprising:
accessing a database of insurance claim records, each insurance claim record including associated risk score and claim outcome; and
wherein the expected claim outcome for the calculated average risk score is determined by analyzing the claim outcomes of insurance claim records having risk scores that are substantially the same as the calculated average risk score.

14. The method according to claim 11, further comprising:
selecting a second subset of the plurality of insurance claim files;
calculating a second average risk score for the second subset of the plurality of insurance claim files; and
determining a second expected claim outcome based on the calculated second average risk score for the second subset of the plurality of insurance claim files.

15. The method according to claim 14, further comprising:
accessing a database of insurance claim records, each insurance claim record including associated risk score and claim outcome; and
wherein the second expected claim outcome for the calculated second average risk score is determined by analyzing the claim outcomes of insurance claim records having risk scores that are substantially the same as the calculated second average risk score.

16. The method according to claim 15, further comprising:
comparing the average risk score to the second average risk score and automatically generating a recommended action based on a difference between the average risk score and the second average risk score.

17. The method according to claim 16, further comprising:
automatically generating an electronic message requesting confirmation that that the recommended action has been implemented.

18. The method according to claim 15, further comprising:
comparing the expected claim outcome to the second expected claim outcome and automatically generating a recommended action based on a difference between the expected claim outcome and the second expected claim outcome.

19. The method according to claim 18, further comprising:
automatically generating an electronic message requesting confirmation that that the recommended action has been implemented.

20. The method according to claim 1, further comprising:
generating an insurance claim record corresponding to each of the plurality of insurance claim files, each insurance claim record including associated risk score and claim outcome.
